(19) United States
(12) Patent Application Publication
(10) Pub. No.: US 2025/0389340 A1
(43) Pub. Date: Dec. 25, 2025

(54) HYDRAULIC PRESSURE-RELIEF VALVE WITH LOW PRESSURE DROOP

(71) Applicant: Hamilton Sundstrand Corporation, Charlotte, NC (US)

(72) Inventor: Francis P. Marocchini, Somers, CT (US)

(21) Appl. No.: 18/751,567

(22) Filed: Jun. 24, 2024

(51) Int. Cl. F16K 17/04

(52) U.S. Cl. CPC F16K 17/046; F16K 17/0466

(57) ABSTRACT

Apparatus and associated methods relate to a hydraulic pressure-relief valve having a path of fluid flow during a pressure-relief event that does not engage a valve control mechanism. Such separation of the path of fluid flow and the valve control mechanism prevents pressure droop caused by momentum exchanges between flowing fluid and the valve control mechanism. Such separation is realized by forming a branched hydraulic channel within a piston portion of a nozzle. A longitudinal branch of the branched hydraulic channel provides fluid to a cylindrical cavity of a slidable sleeve that is slidably coupled to the piston portion of the nozzle. A radial branch of the branched hydraulic channel is selectively blocked by a slidable sleeve, which functions as the control mechanism. In response to pressure of hydraulic fluid in the cylindrical cavity, the slidable sleeve longitudinally slides away from the nozzle thereby exposing the pressure-relief port.

### BACKGROUND

Hydraulic pressure-relief valves are safety devices used in many hydraulic systems. Such hydraulic pressure-relief valves are used to limit the pressure in a hydraulic system by providing an auxiliary path for the hydraulic fluid in response to the pressure of the hydraulic fluid exceeding a pressure-relief threshold. Some pressure-relief valves have an adjustment mechanism that permits a user to adjust the pressure-relief threshold at which the auxiliary path for hydraulic fluid is provided. Typically, the auxiliary path is created in response to a valve seat opening in response to the pressure of the hydraulic fluid exceeding a pressure-relief threshold. After the valve seat has opened, the auxiliary path siphons away some of the hydraulic fluid, thereby reducing the pressure of the remaining hydraulic fluid. The fluid that flows along the auxiliary path has a momentum associated with it. Momentum exchange between the flowing fluid and the valve seat can cause the valve to remain open even when the pressure of the flowing fluid drops below the pressure-relief threshold. Such a phenomenon is called pressure droop, or simply droop.

### SUMMARY

Some embodiments relate to a hydraulic pressure-relief valve that includes a nozzle in which a branched hydraulic channel is formed. The nozzle includes an inlet portion and a cylindrical piston portion. The branched hydraulic channel has a radial branch branching from a longitudinal trunk. The longitudinal trunk is formed along a longitudinal axis through the nozzle between the inlet portion and the piston portion. The radial branch is formed between the longitudinal trunk and a pressure-relief port formed in a lateral sidewall of the cylindrical piston portion. The hydraulic pressure-relief valve includes a slidable sleeve slidably coupled with the cylindrical piston portion of the nozzle. The slidable sleeve is configured to slidably block and/or unblock the pressure relief port of the branched hydraulic channel in response to fluid provided thereto via the longitudinal trunk of the branched hydraulic channel. The hydraulic pressure-relief valve also includes a spring attached to the slidable sleeve so as to provide a longitudinal force to the slidable sleeve in a blocking direction parallel with the longitudinal axis. The slidable sleeve is configured to longitudinally slide so as to unblock the pressure-relief port in response to pressure of hydraulic fluid provided to the slidable sleeve via the longitudinal trunk of the branched hydraulic channel producing a force that exceeds the longitudinal force of the spring.

Some embodiments relate to a hydraulic pressure-relief valve that includes a nozzle, a slidable sleeve and a spring. The nozzle has an inlet portion and a cylindrical piston portion extending from the inlet portion about a longitudinal axis. A hydraulic channel is formed along the longitudinal axis through the nozzle between the inlet portion and the piston portion. The hydraulic channel is configured to provide fluid communication through the nozzle. A restrictive orifice separates a restricted region of the hydraulic channel from an unrestricted region of the hydraulic channel. The restrictive orifice is configured to restrict fluid flow therebetween. A pressure-relief port is formed in a lateral sidewall of the cylindrical piston portion. The pressure-relief port is in fluid communication with the unrestricted region of the hydraulic channel. A cylindrical cavity is formed within the slidable sleeve. The cylindrical cavity has an open end configured to slidably engage the cylindrical piston portion of the nozzle. The cylindrical cavity is in fluid communication with the restrictive region of the hydraulic channel. A valve seat is formed at and circumscribes the open end of cylindrical cavity. The valve seat is configured to slidably engage a mating surface of the nozzle in a circumscribing fashion, thereby blocking fluid flow through the pressure-relief port. The spring is attached to the slidable sleeve so as to provide a longitudinal force to the slidable sleeve in a direction parallel with the longitudinal axis and toward the mating surface of the nozzle. In response to pressure of hydraulic fluid in the cylindrical cavity producing a force that exceeds the longitudinal force of the spring, the slidable sleeve longitudinally slides away from the nozzle thereby disengaging the valve seat from the mating surface of the nozzle and exposing the pressure-relief port.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a cutaway view of an embodiment of a hydraulic pressure-relief valve relieving pressure within a hydraulic system.

FIG. 2 is an exploded view of an embodiment of a hydraulic pressure-relief valve.

FIGS. 3A and 3B are cross-sectional views and a perspective view of an embodiment of a hydraulic pressure-relief valve.

FIGS. 4A and 4B are cross sectional and perspective views of the nozzle and sliding sleeve of an embodiment of a hydraulic pressure-relief valve.

FIG. 5 is a graph depicting pressure-flow relations for various hydraulic pressure-relief valves.

### DETAILED DESCRIPTION

Apparatus and associated methods relate to a hydraulic pressure-relief valve having a path of fluid flow during a pressure-relief event that does not engage a valve control mechanism. Such separation of the path of fluid flow and the valve control mechanism prevents pressure droop caused by momentum exchanges between flowing fluid and the valve control mechanism. Such separation is realized by forming a branched hydraulic channel within a piston portion of a nozzle. A longitudinal branch of the branched hydraulic channel provides fluid to a cylindrical cavity of a slidable sleeve that is slidably coupled to the piston portion of the nozzle. A radial branch of the branched hydraulic channel is selectively blocked by a slidable sleeve, which functions as the control mechanism. In response to pressure of hydraulic fluid in the cylindrical cavity, the slidable sleeve longitudinally slides away from the nozzle thereby exposing the pressure-relief port.

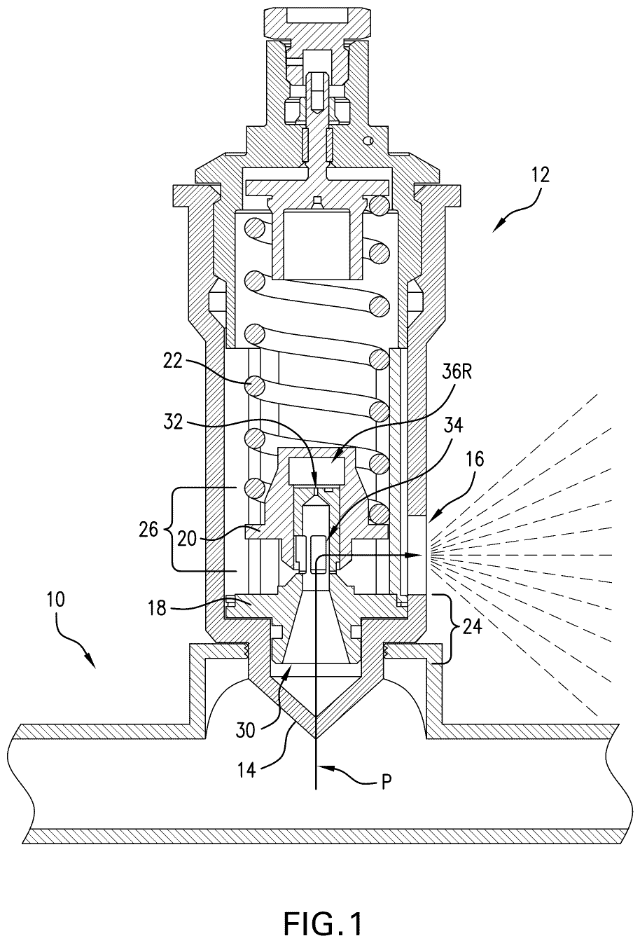

FIG. 1 is a cutaway view of an embodiment of a hydraulic pressure-relief valve relieving pressure within a hydraulic system. In FIG. 1, hydraulic system 10 includes hydraulic pressure-relief valve 12, which is depicted as being open and spewing hydraulic fluid from hydraulic system 10. Hydraulic pressure-relief valve 12 has established a fluid path P of fluid flow from system port 14 to ejection port 16. Fluid path P of fluid flow can be selectively established (e.g., blocked and unblocked) based on pressure of the hydraulic fluid at system port 14. Hydraulic pressure-relief valve 12 has established fluid path P using nozzle 18, slidable sleeve 20 and spring 22. Nozzle 18 has inlet portion 24 and cylindrical piston portion 26 extending from inlet portion 24. Cylindrical piston portion 26 defines longitudinal axis L and extends thereabout.

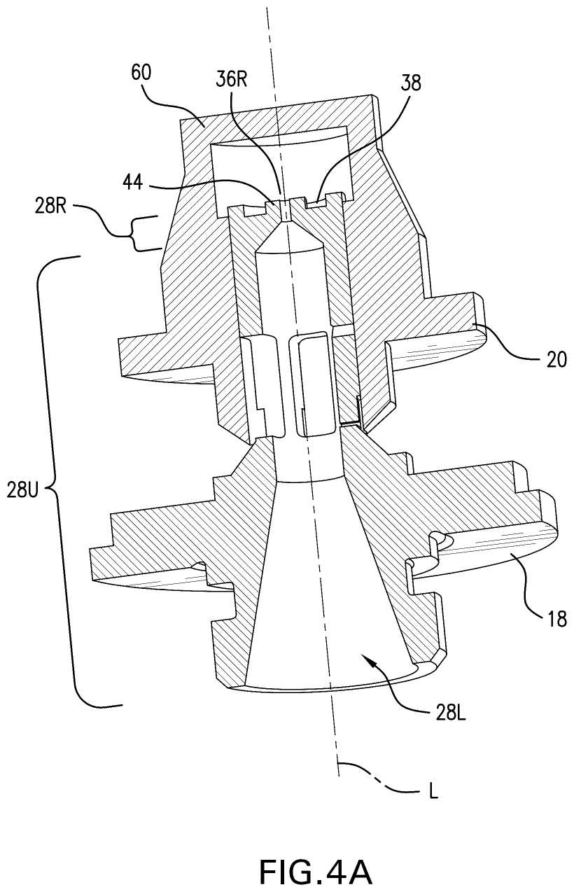

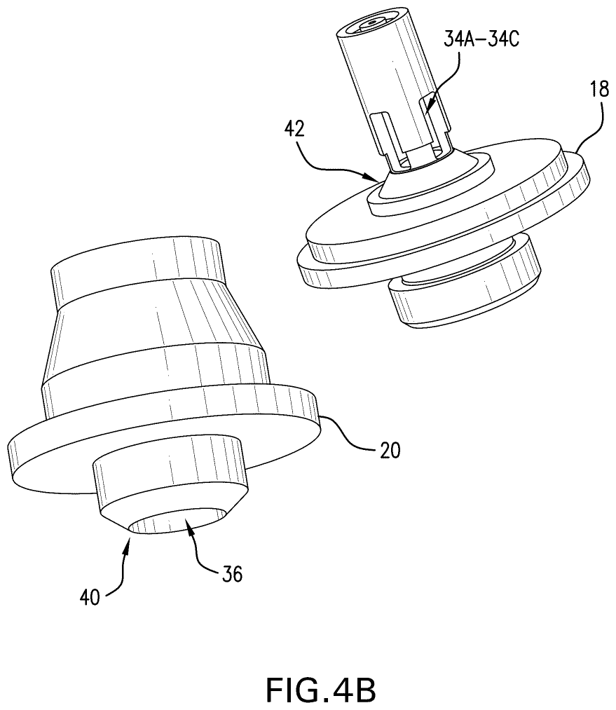

Branched hydraulic channel 28 is formed within nozzle 18. Branched hydraulic channel 28 has a longitudinal trunk 28L and radial branch 28R (shown axially) that radially extends from or taps into longitudinal trunk 28L (which are labeled and depicted more clearly in FIGS. 4A and 4B). Longitudinal trunk 28L of branched hydraulic channel 28 provides fluid communication between sampling port 30 and cavity port 32. Radial branch 28R of branched hydraulic channel 28 provides fluid communication between longitudinal trunk 28L and pressure-relief port 34. Pressure relief port 34 is selectively blocked or unblocked by slidable sleeve 20, which is configured to be slidably received on cylindrical piston portion 16 of nozzle 18. Hydraulic fluid can flow along fluid path P in response to pressure-relief port 34 being unblocked. Conversely, hydraulic fluid cannot flow along fluid path P in response to pressure-relief port 34 being blocked. In the FIG. 1 depiction, slidable sleeve has been slid up from a closed position to an open position, thereby unblocking pressure-relief port 34, thereby establishing fluid path P.

Cylindrical cavity 36 is formed within slidable sleeve 20. Cylindrical cavity 36 is configured to be slidably received by cylindrical piston portion 26 of nozzle 18. To be so slidably received by cylindrical piston portion 26 of nozzle 18, cylindrical cavity 36 is configured to complement the shape of cylindrical piston portion 26 of nozzle 18, at least where interior surfaces of cylindrical cavity 36 engage exterior surfaces of cylindrical piston portion 26. When cylindrical cavity 36 is fully received by cylindrical piston portion 26 of nozzle 18, valve seat 40 of slidable sleeve 20 engages complementary mating surface 42 of nozzle 18 (which are labeled and depicted more clearly in FIGS. 4A and 4B), thereby sealably blocking fluid path P. Valve seat 40 is located at and circumscribes open end 44 of cylindrical cavity 36. Valve seat 40 is configured to slidably engage complementary mating surface 42 of nozzle 18 in a circumscribing fashion. In some embodiments, each of valve seat 40 of slidable sleeve 20 and complementary mating surface 42 of nozzle 18 has circular symmetry centered on longitudinal axis L.

Spring 22 is attached to slidable sleeve 20 so as to provide a longitudinal force to slidable sleeve 22 in a direction parallel with the longitudinal axis L and toward complementary mating surface 42 of nozzle 18. Because of such a longitudinal force provided by spring 22, pressure-relief port 34 is normally blocked, thereby preventing fluid flow along fluid path P. Slidable sleeve 20 can, however, be slid away from nozzle 18, in response to pressure of hydraulic fluid in cylindrical cavity 36 producing a force that exceeds the longitudinal force of spring 22, as is depicted in FIG. 1. When slidable sleeve 20 is longitudinally slid away from nozzle 18, valve seat 40 disengages from complementary mating surface 42 of nozzle 18 and pressure-relief port 34 is unblocked or exposed, thereby enabling fluid flow along fluid path P.

Cylindrical cavity 36 extends beyond longitudinal end 38 of cylindrical piston portion 26 of nozzle 18 (which are both labeled and depicted more clearly in FIGS. 4A and 4B), even when slidable sleeve 20 if fully received by cylindrical piston portion 26 of nozzle 18. Residual cavity portion 36R is the portion of cylindrical cavity 36 that extends beyond cylindrical piston portion 26 of nozzle 18. Residual cavity portion 36R is in fluid communication with branched hydraulic channel 28 via cavity port 32. Because residual cavity portion 36R is in fluid communication with sampling port 28, pressure of hydraulic fluid in residual cavity portion 36R is related to pressure of hydraulic fluid in branched hydraulic channel 28. For example, in steady-state conditions, the pressure of hydraulic fluid in residual cavity portion 36R is equal to pressure of hydraulic fluid in branched hydraulic channel 28. In dynamic conditions, however, pressure differences between such locations can be different, in part due to restrictive orifice 44.

Restrictive orifice 44 (labeled and depicted more clearly in FIGS. 4A and 4B) separates restricted region 28R of the hydraulic channel 28 from unrestricted region 28U of hydraulic channel 28 (labeled and depicted more clearly in FIGS. 4A and 4B). Restrictive orifice 44 is configured to restrict fluid flow therebetween. Restrictive orifice 44 is sized so as to dampen a pressure response within cylindrical cavity 36 to dynamic pressure variations of the hydraulic fluid in the unrestricted region 28U of branched hydraulic channel 28. Such dampening of the pressure response within cylindrical cavity 36 reduces pressure and flow response in the longitudinal direction between hydraulic fluid entering residual cavity portion 36R and slidable sleeve 20. Use of restrictive orifice 44 also results in low-pass filtering of the pressure response within cylindrical cavity 36 to dynamic pressure variations of the hydraulic fluid in the unrestricted region 28U of branched hydraulic channel 28.

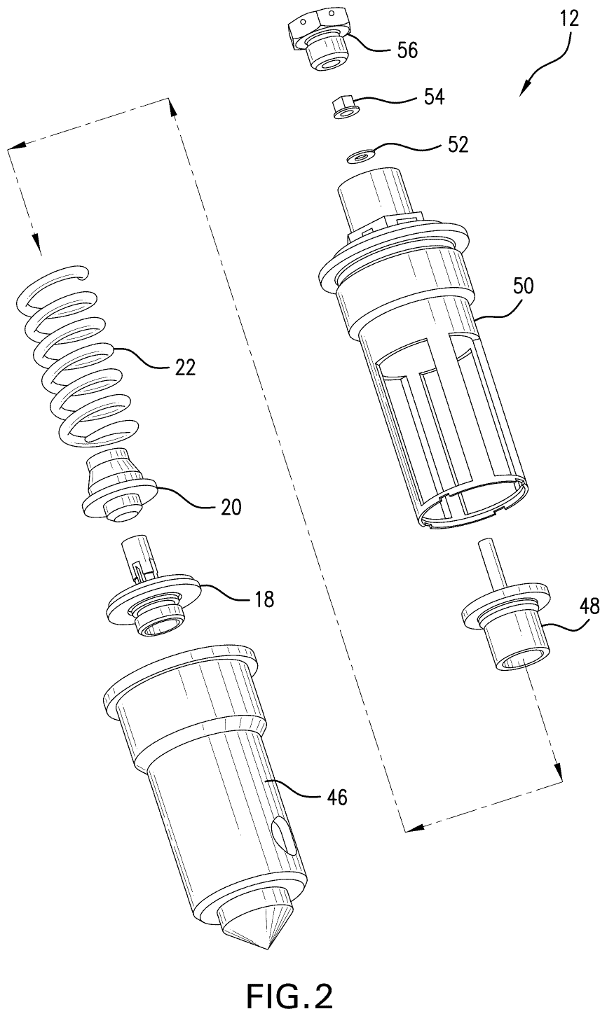

FIG. 2 is an exploded view of an embodiment of a hydraulic pressure-relief valve. In FIG. 2, hydraulic pressure-relief valve 12 includes bore 46, nozzle 18, slidable sleeve 20, spring 22, adjustable spring seat 48, closure 50, washer 52, locknut 54 and plug 56. Bore 46, closure 50, and plug 56 form sealed enclosure 58 of hydraulic pressure-relief valve 12. Bore 46 is depicted with a conical shaped filter, in which one or more aperture is formed so as to permit hydraulic fluid to flow into hydraulic pressure-relief valve 12. Bore 46 can be configured to attach to a hydraulic system using various attachment mechanisms, such as, for example, screw thread, clamp, welding, etc. The longitudinal force of spring 22 can be adjusted by extending or retracting adjustable spring seat 48 within sealed enclosure 58. Once adjusted, adjustable spring seat 48 can be secured in position using washer 52 and locknut 54.

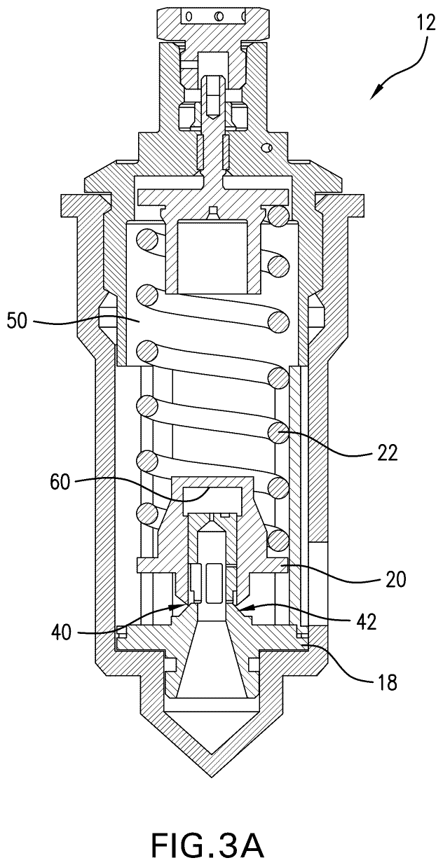

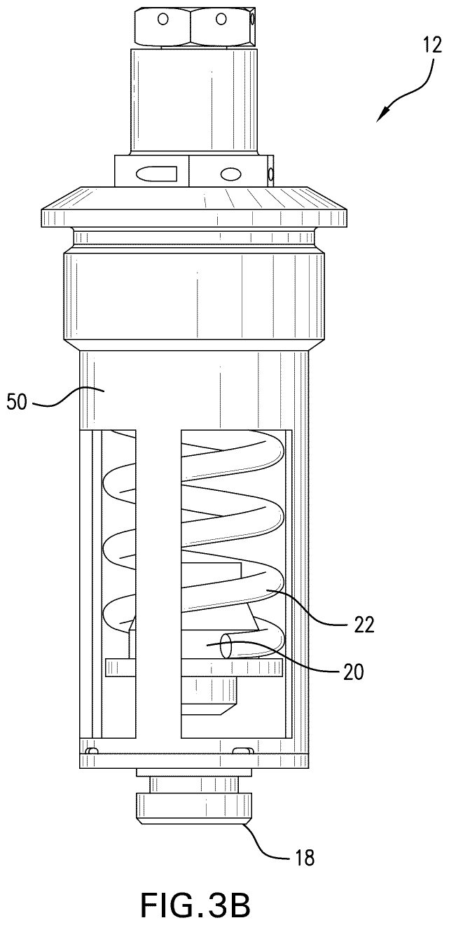

FIGS. 3A and 3B are cross-sectional views and a perspective view of an embodiment of a hydraulic pressure-relief valve. In FIGS. 3A and 3B, hydraulic pressure-relief valve 12 is depicted in a closed position, in which slidable sleeve 20 is fully received by cylindrical piston portion of nozzle 18, thereby causing valve seat 40 of slidably sleeve 20 to sealably engage complementary mating surface 42 of nozzle 18. In such a configuration, pressure-relief ports 34A-34D are blocked by slidable sleeve 20, thereby interrupting fluid path P. Notable in FIG. 3A, are the large apertures in closure 50, which make fluid flow through closure 50 largely unimpeded. Also notable in FIG. 3A is the extent in which residual cavity portion 36R extends beyond longitudinal end 38 of cylindrical piston portion 36 of nozzle 18. Because of such an extension of residual cavity portion 36R beyond longitudinal end 38 of cylindrical piston portion 36 of nozzle 18, pressure within residual cavity portion 36R provides a longitudinal force over the entire area of closed bottom surface 60 of residual cavity portion 36R, and not just over a cross-sectional area of restrictive orifice 44.

FIGS. 4A and 4B are cross sectional and perspective views of the nozzle and sliding sleeve of an embodiment of a hydraulic pressure-relief valve. In FIGS. 4A and 4B, details of nozzle 18 and slidable sleeve 20 are readily observable. Notable in FIGS. 4A and 4B are the number and size of pressure-relief ports 34A-34C. In the depicted embodiment, a plurality of pressure-relief ports 34A-34C are formed in the sidewall of cylindrical piston portion 26 of nozzle 18. Each of the plurality of pressure-relief ports 34A-34C has an area, as measure in direction of fluid flow (e.g., in a radial direction) that is greater than a cross sectional area of restrictive orifice 44. In some embodiments, a ratio of the areas of each of the plurality of pressure-relief ports 34A-34C to the cross-sectional area of restrictive orifice 44 as measured in directions parallel to the path of fluid flow is greater than 10:1. Such ratios ensure that fluid flow during a pressure-relief event is relatively unrestricted, whereas, fluid flow into the residual cavity portion 36R is relatively restricted, thereby inhibiting pressure spikes between the hydraulic fluid and slidable sleeve 20. Also notable in FIG. 4A are the restricted 28R and unrestricted 28U regions of longitudinal trunk of longitudinal trunk 28L of branched hydraulic channel 28. Although restrictive orifice 44 is depicted at longitudinal end 38 of cylindrical piston portion of nozzle 18, restrictive orifice 44 can be located anywhere between pressure-relief ports 34A-34C and cavity port.

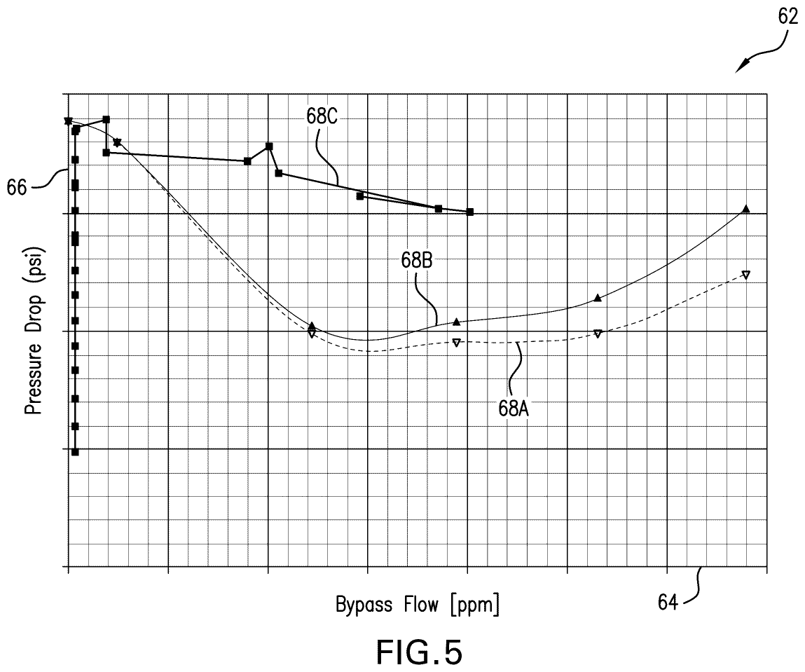

FIG. 5 is a graph depicting pressure-flow relations for various hydraulic pressure-relief valves. In FIG. 5, graph 62 includes horizontal axis 64, vertical axis 66 and pressure-flow relations 68A-68C. Horizontal axis 64 is indicative of fluid flow through a hydraulic pressure-relief valve. Vertical axis 66 is indicative of pressure of hydraulic within a hydraulic pressure-relief valve. Pressure-flow relations 68A and 68B correspond to prior art hydraulic pressure-relief valves. Each of pressure-flow relations 68A and 68B show significant pressure droop (i.e., pressure difference between the initial pressure where fluid flow is zero (i.e., where pressure-flow relations 68A and 68B intersect vertical axis 66) and minimum pressure points where fluid flow is much greater than zero. Pressure-flow relations 68C corresponds to hydraulic pressure-relief valve 12, as depicted in FIGS. 1-4B. Pressure droop, as indicated in pressure-flow relation 68C, is modest in comparison with pressure droops as indicated in pressure-flow relations 68A and 68B. Such modest droop is a result of separating the path of fluid flow from the valve control mechanism (i.e., slidable sleeve) in the direction of actuation (i.e., in the longitudinal direction in which the slidable sleeve slides).

### Discussion of Possible Embodiments

The following are non-exclusive descriptions of possible embodiments of the present invention.

Some embodiments relate to a hydraulic pressure-relief valve that includes a nozzle in which a branched hydraulic channel is formed. The nozzle includes an inlet portion and a cylindrical piston portion. The branched hydraulic channel has a radial branch branching from a longitudinal trunk. The longitudinal trunk is formed along a longitudinal axis through the nozzle between the inlet portion and the piston portion. The radial branch is formed between the longitudinal trunk and a pressure-relief port formed in a lateral sidewall of the cylindrical piston portion. The hydraulic pressure-relief valve includes a slidable sleeve slidably coupled with the cylindrical piston portion of the nozzle. The slidable sleeve is configured to slidably block and/or unblock the pressure relief port of the branched hydraulic channel in response to fluid provided thereto via the longitudinal trunk of the branched hydraulic channel. The hydraulic pressure-relief valve also includes a spring attached to the slidable sleeve so as to provide a longitudinal force to the slidable sleeve in a blocking direction parallel with the longitudinal axis. The slidable sleeve is configured to longitudinally slide so as to unblock the pressure-relief port in response to pressure of hydraulic fluid provided to the slidable sleeve via the longitudinal trunk of the branched hydraulic channel producing a force that exceeds the longitudinal force of the spring.

The system of the preceding paragraph can optionally include, additionally and/or alternatively, any one or more of the following features, configurations and/or additional components:

A further embodiment of the foregoing system can further include a restrictive orifice separating a restricted region of the longitudinal trunk from an unrestricted region of the branched hydraulic channel. The restrictive orifice can be configured to restrict fluid flow therebetween. The slidable sleeve can include a cylindrical cavity formed within the slidable sleeve. The cylindrical cavity can be configured to be slidably received by the cylindrical piston portion of the nozzle. The cylindrical cavity can be in fluid communication with the restrictive region of the longitudinal trunk. The slidable sleeve can further include a valve seat at and circumscribing an open end of cylindrical cavity, the valve seat configured to slidably engage a complementary mating surface of the nozzle in a circumscribing fashion thereby blocking fluid flow through the pressure-relief port.

A further embodiment of any of the foregoing systems can further include an enclosure that houses the nozzle, the slidable sleeve, and the spring. The nozzle can be fixedly attached to the enclosure at a first longitudinal end. The spring can be attached between a second longitudinal end of the enclosure and the slidable sleeve. The enclosure can have a system port and an ejection port. The system port can be configured in fluid communication with the unrestricted region of the branched hydraulic channel of the nozzle, the ejection port in fluid communication with the pressure-relief port of the nozzle.

A further embodiment of any of the foregoing systems can further include a spring tensioning mechanism coupled between the spring and the second longitudinal end of the enclosure.

A further embodiment of any of the foregoing systems, wherein the enclosure can include metal, and the nozzle can be conductively coupled with the enclosure.

A further embodiment of any of the foregoing systems, wherein the cylindrical cavity can have a closed bottom surface. Pressure of hydraulic fluid in the cylindrical cavity can produce the force against the closed bottom surface of the cavity that is in a direction parallel with the longitudinal axis and away from the nozzle.

A further embodiment of any of the foregoing systems, wherein the nozzle can further include a sampling port where the hydraulic channel enters the inlet portion of the nozzle and a cavity port where the hydraulic channel exits the piston portion of the nozzle.

A further embodiment of any of the foregoing systems, wherein, in response to pressure of hydraulic fluid in the cylindrical cavity producing a force that exceeds the longitudinal force of the spring, a path of fluid flow can be formed from the sampling port into the unrestricted portion of the channel and out the pressure-relief port.

A further embodiment of any of the foregoing systems, wherein a ratio of the areas of the pressure-relief port to the restrictive orifice as measured in directions parallel to the path of fluid flow can be greater than 10:1.

A further embodiment of any of the foregoing systems, wherein the pressure-relief port in the exterior wall of the nozzle can be a first of a plurality of pressure-relief ports in the exterior wall of the nozzle.

A further embodiment of any of the foregoing systems, wherein a ratio of the areas of the plurality of pressure-relief ports to the restrictive orifice as measured in directions parallel to the path of fluid flow can be greater than 30:1.

A further embodiment of any of the foregoing systems, wherein the piston portion of the nozzle can further include a longitudinal end, in which the cavity port is located.

A further embodiment of any of the foregoing systems, wherein engagement of the valve seat of the sliding sleeve with the complementary mating surface of the nozzle can limit an extent in which the slidable sleeve can be slidably received by the cylindrical piston portion of the nozzle.

A further embodiment of any of the foregoing systems, wherein the cylindrical cavity formed within the slidable sleeve can extend beyond the longitudinal end of the cylindrical piston portion of the nozzle when the valve seat of the sliding sleeve engages the complementary mating surface of the nozzle, thereby forming a residual cavity portion of the cylindrical cavity.

A further embodiment of any of the foregoing systems, wherein a ratio of the areas of the cylindrical cavity to the restrictive orifice as measured in planes perpendicular to the longitudinal axis can be greater than 10:1.

A further embodiment of any of the foregoing systems, wherein an interior surface of the cylindrical cavity of the slidable sleeve can be configured to sealably engage an exterior surface of the cylindrical piston portion of the nozzle, thereby inhibiting fluid flow therebetween.

A further embodiment of any of the foregoing systems, wherein the valve seat and the complementary mating surface can include metal so that engagement of the valve seat with the complementary mating surface is a metal-to-metal engagement.

A further embodiment of any of the foregoing systems, wherein one of the valve seat and the mating surface can be configured as a knife-edge.

A further embodiment of any of the foregoing systems, wherein each of the valve seat of the slidable sleeve and the complementary mating surface of the nozzle can have circular symmetry centered on the longitudinal axis.

A further embodiment of any of the foregoing systems, wherein each of the hydraulic channel through the nozzle and the cylindrical cavity of the slidable sleeve can be centered on the longitudinal axis.

A further embodiment of any of the foregoing systems, wherein the restrictive orifice can be sized so as to dampen a pressure response within the cylindrical cavity to dynamic pressure variations of the hydraulic fluid in the hydraulic channel.

Some embodiments relate to a hydraulic pressure-relief valve that includes a nozzle, a slidable sleeve and a spring. The nozzle has an inlet portion and a cylindrical piston portion extending from the inlet portion about a longitudinal axis. A hydraulic channel is formed along the longitudinal axis through the nozzle between the inlet portion and the piston portion. The hydraulic channel is configured to provide fluid communication through the nozzle. A restrictive orifice separates a restricted region of the hydraulic channel from an unrestricted region of the hydraulic channel. The restrictive orifice is configured to restrict fluid flow therebetween. A pressure-relief port is formed in a lateral sidewall of the cylindrical piston portion. The pressure-relief port is in fluid communication with the unrestricted region of the hydraulic channel. A cylindrical cavity is formed within the slidable sleeve. The cylindrical cavity has an open end configured to slidably engage the cylindrical piston portion of the nozzle. The cylindrical cavity is in fluid communication with the restrictive region of the hydraulic channel. A valve seat is formed at and circumscribes the open end of cylindrical cavity. The valve seat is configured to slidably engage a mating surface of the nozzle in a circumscribing fashion, thereby blocking fluid flow through the pressure-relief port. The spring is attached to the slidable sleeve so as to provide a longitudinal force to the slidable sleeve in a direction parallel with the longitudinal axis and toward the mating surface of the nozzle. In response to pressure of hydraulic fluid in the cylindrical cavity producing a force that exceeds the longitudinal force of the spring, the slidable sleeve longitudinally slides away from the nozzle thereby disengaging the valve seat from the mating surface of the nozzle and exposing the pressure-relief port.

It will be recognized that the invention is not limited to the implementations so described but can be practiced with modification and alteration without departing from the scope of the appended claims. For example, the above implementations may include specific combinations of features. However, the above implementations are not limited in this regard, and, in various implementations, the above implementations may include the undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

1. A hydraulic pressure-relief valve comprising:
a nozzle in which a branched hydraulic channel is formed, the nozzle including an inlet portion and a cylindrical piston portion, the branched hydraulic channel having a radial branch branching from a longitudinal trunk, the longitudinal trunk formed along a longitudinal axis through the nozzle between the inlet portion and the piston portion, the radial branch formed between the longitudinal trunk and a pressure-relief port formed in a lateral sidewall of the cylindrical piston portion;
a slidable sleeve slidably coupled with the cylindrical piston portion of the nozzle, the slidable sleeve configured to slidably block and/or unblock the pressure relief port of the branched hydraulic channel in response to fluid provided thereto via the longitudinal trunk of the branched hydraulic channel; and
a spring attached to the slidable sleeve so as to provide a longitudinal force to the slidable sleeve in a blocking direction parallel with the longitudinal axis,
wherein the slidable sleeve is configured to longitudinally slide so as to unblock the pressure-relief port in response to pressure of hydraulic fluid provided to the slidable sleeve via the longitudinal trunk of the branched hydraulic channel producing a force that exceeds the longitudinal force of the spring.

2. The hydraulic pressure-relief valve of claim 1, further comprising:
a restrictive orifice separating a restricted region of the longitudinal trunk from an unrestricted region of the branched hydraulic channel, the restrictive orifice configured to restrict fluid flow therebetween,
wherein the slidable sleeve includes:
a cylindrical cavity formed within the slidable sleeve, the cylindrical cavity configured to be slidably received by the cylindrical piston portion of the nozzle, the cylindrical cavity in fluid communication with the restrictive region of the longitudinal trunk; and
a valve seat at and circumscribing an open end of cylindrical cavity, the valve seat configured to slidably engage a complementary mating surface of the nozzle in a circumscribing fashion thereby blocking fluid flow through the pressure-relief port.

3. The hydraulic pressure-relief valve of claim 2, further comprising:
an enclosure that houses the nozzle, the slidable sleeve, and the spring, the nozzle being fixedly attached to the enclosure at a first longitudinal end, the spring attached between a second longitudinal end of the enclosure and the slidable sleeve, the enclosure having a system port and an ejection port, the system port configured in fluid communication with the unrestricted region of the branched hydraulic channel of the nozzle, the ejection port in fluid communication with the pressure-relief port of the nozzle.

4. The hydraulic pressure-relief valve of claim 3, further comprising:
a spring tensioning mechanism coupled between the spring and the second longitudinal end of the enclosure.

5. The hydraulic pressure-relief valve of claim 3, wherein the enclosure comprises metal, and the nozzle is conductively coupled with the enclosure.

6. The hydraulic pressure-relief valve of claim 2, wherein:
the cylindrical cavity has a closed bottom surface, and
pressure of hydraulic fluid in the cylindrical cavity produces the force against the closed bottom surface of the cavity that is in a direction parallel with the longitudinal axis and away from the nozzle.

7. The hydraulic pressure-relief valve of claim 2, wherein the nozzle further includes:
a sampling port where the hydraulic channel enters the inlet portion of the nozzle; and
a cavity port where the hydraulic channel exits the piston portion of the nozzle.

8. The hydraulic pressure-relief valve of claim 7, wherein, in response to pressure of hydraulic fluid in the cylindrical cavity producing a force that exceeds the longitudinal force of the spring, a path of fluid flow is formed from the sampling port into the unrestricted portion of the channel and out the pressure-relief port.

9. The hydraulic pressure-relief valve of claim 8, wherein a ratio of the areas of the pressure-relief port to the restrictive orifice as measured in directions parallel to the path of fluid flow is greater than 10:1.

10. The hydraulic pressure-relief valve of claim 7, wherein the pressure-relief port in the exterior wall of the nozzle is a first of a plurality of pressure-relief ports in the exterior wall of the nozzle.

11. The hydraulic pressure-relief valve of claim 10, wherein a ratio of the areas of the plurality of pressure-relief ports to the restrictive orifice as measured in directions parallel to the path of fluid flow is greater than 30:1.

12. The hydraulic pressure-relief valve of claim 7, wherein the piston portion of the nozzle further includes:
a longitudinal end, in which the cavity port is located.

13. The hydraulic pressure-relief valve of claim 12, wherein engagement of the valve seat of the sliding sleeve with the complementary mating surface of the nozzle limits an extent in which the slidable sleeve can be slidably received by the cylindrical piston portion of the nozzle.

14. The hydraulic pressure-relief valve of claim 12, wherein the cylindrical cavity formed within the slidable sleeve extends beyond the longitudinal end of the cylindrical piston portion of the nozzle when the valve seat of the sliding sleeve engages the complementary mating surface of the nozzle, thereby forming a residual cavity portion of the cylindrical cavity.

15. The hydraulic pressure-relief valve of claim 2, wherein a ratio of the areas of the cylindrical cavity to the restrictive orifice as measured in planes perpendicular to the longitudinal axis is greater than 10:1.

16. The hydraulic pressure-relief valve of claim 2, wherein an interior surface of the cylindrical cavity of the slidable sleeve is configured to sealably engage an exterior surface of the cylindrical piston portion of the nozzle, thereby inhibiting fluid flow therebetween.

17. The hydraulic pressure-relief valve of claim 2, wherein the valve seat and the complementary mating surface comprise metal so that engagement of the valve seat with the complementary mating surface is a metal-to-metal engagement.

18. The hydraulic pressure-relief valve of claim 17, wherein one of the valve seat and the mating surface is configured as a knife-edge, and wherein each of the valve seat of the slidable sleeve and the complementary mating surface of the nozzle has circular symmetry centered on the longitudinal axis.

19. The hydraulic pressure-relief valve of claim 2, wherein each of the hydraulic channel through the nozzle and the cylindrical cavity of the slidable sleeve is centered on the longitudinal axis.

20. A hydraulic pressure-relief valve comprising:
a nozzle having an inlet portion and a cylindrical piston portion extending from the inlet portion about a longitudinal axis, the nozzle further includes:
a branched hydraulic channel having a longitudinal trunk and a radial branch, the longitudinal trunk formed along the longitudinal axis through the nozzle between the inlet portion and the piston portion, the radial branch formed between a pressure relief port formed in a lateral sidewall of the cylindrical piston portion and the longitudinal trunk;
a restrictive orifice separating a restricted region of the longitudinal trunk from an unrestricted region of the branched hydraulic channel, the restrictive orifice configured to restrict fluid flow therebetween; and
a slidable sleeve including:
a cylindrical cavity formed within the slidable sleeve, the cylindrical cavity configured to be slidably received by the cylindrical piston portion of the nozzle, the cylindrical cavity in fluid communication with the restrictive region of the longitudinal trunk; and
a valve seat at and circumscribing an open end of cylindrical cavity, the valve seat configured to slidably engage a complementary mating surface of the nozzle in a circumscribing fashion thereby blocking fluid flow through the pressure-relief port; and
a spring attached to the slidable sleeve so as to provide a longitudinal force to the slidable sleeve in a direction parallel with the longitudinal axis and toward the complementary mating surface of the nozzle,
wherein, in response to pressure of hydraulic fluid in the cylindrical cavity producing a force that exceeds the longitudinal force of the spring, the slidable sleeve longitudinally slides away from the nozzle thereby disengaging the valve seat from the complementary mating surface of the nozzle and exposing the pressure-relief port.
